(19) United States
(12) Patent Application Publication
(10) Pub. No.: US 2017/0246534 A1
(43) Pub. Date: Aug. 31, 2017

(54) System and Method for Enhanced Immersion Gaming Room

(71) Applicant: Kent A. Johnson, Augusta, KS (US)

(72) Inventor: Kent A. Johnson, Augusta, KS (US)

(21) Appl. No.: 15/055,313

(22) Filed: Feb. 26, 2016

(51) Int. Cl. A63F 13/27; A63F 13/98

(52) U.S. Cl. CPC A63F 13/27; A63F 13/98

(57) ABSTRACT

A method and system for a gaming system which uses a plurality of display devices to emit gaming content onto the walls of an immersion room and allows a plurality of players to interact with a gaming application through hand-held controllers. The method includes generating graphical data and audio data by running a gaming application or a video application with a server. The graphic data is then displayed onto an at least one wall of the immersion room with the display devices. At the same time the audio data is sounded by the plurality of integrated speakers. User input is received through the hand-held controller and converted into primary application commands. The primary application commands are then executed by the server to modify the graphical data and the audio data. The aforementioned steps are then repeated with the modified graphical data and audio data.

### FIELD OF THE INVENTION

The present invention relates generally to video game system. More specifically, the present invention is a method for a method for an immersion video game system that utilizes a plurality of display devices to project/display gaming content onto the walls of a room and allowing a plurality of users to interact with the game through hand-held controllers.

### BACKGROUND OF THE INVENTION

Within the past couple of years visual and computing technologies have been becoming progressively more complex and powerful while simultaneously decrease in size and power requirement. One of the fields that have prospered due to these technological advances is the gaming industry. In the gaming industry, for the longest period of time, graphics quality and speed of the gaming content was a direct indicator of the quality of the game. These attributes directly influenced sales and in turn profit, but with the immergence of new technology the graphics of games have increased in quality to the point where companies have resorted to alternative means for standing out among the competition. Gaming consoles/companies have begun to branch out of standard gaming traditions by changing the gaming interface and gaming controls. These interactions include motion sensors in the controllers, motion detection systems which utilizes the user's movement as input for the game. Additionally, another very popular approach is using a helmet or goggles to immerse the player in a virtual reality.

The present invention provides alternative gaming experience which provides a unique and a novel experience for a multitude of people at the same time. The present invention utilizes the walls of a simple room as the display surfaces to fully immerse a single user or a multitude of users simultaneously. The present invention further creates an enhanced virtual experience for the user through the use of a surround sound system and hand-held portable controllers.

### BRIEF DESCRIPTION OF THE DRAWINGS

FIG. 1 is a transparent perspective view of the system portion of the present invention.

FIG. 2 is a system diagram of the present invention.

FIG. 3 is a flowchart illustrating the overall process of the present invention.

FIG. 4 is a flowchart illustrating the sub-steps necessary for receiving user input through a hand-held controller and displaying user-specific data through the hand-held controller.

FIG. 5 is a flowchart illustrating the sub-steps necessary for sounding user-specific data through the hand-held controller.

FIG. 6 is a flowchart illustrating an alternative embodiment of the present invention, wherein a first immersion room and a second immersion room interact with the same gaming application.

FIG. 7 is a flowchart illustrating the sub-steps necessary for enabling verbal communications in between user accounts in the first immersion room and user accounts in the second immersion room.

FIG. 8 is a flowchart illustration the sub-steps necessary for allowing an external computing device to interact with the gaming application, wherein the external computing device is located outside the immersion room.

FIG. 9 is a flowchart illustration the sub-steps necessary for utilizing a motion tracking system as a form of user input for the gaming application.

FIG. 10 is a flowchart illustrating the steps necessary for emitting a single continuous video image onto an inner surface of the immersion room.

### DETAIL DESCRIPTIONS OF THE INVENTION

All illustrations of the drawings are for the purpose of describing selected versions of the present invention and are not intended to limit the scope of the present invention.

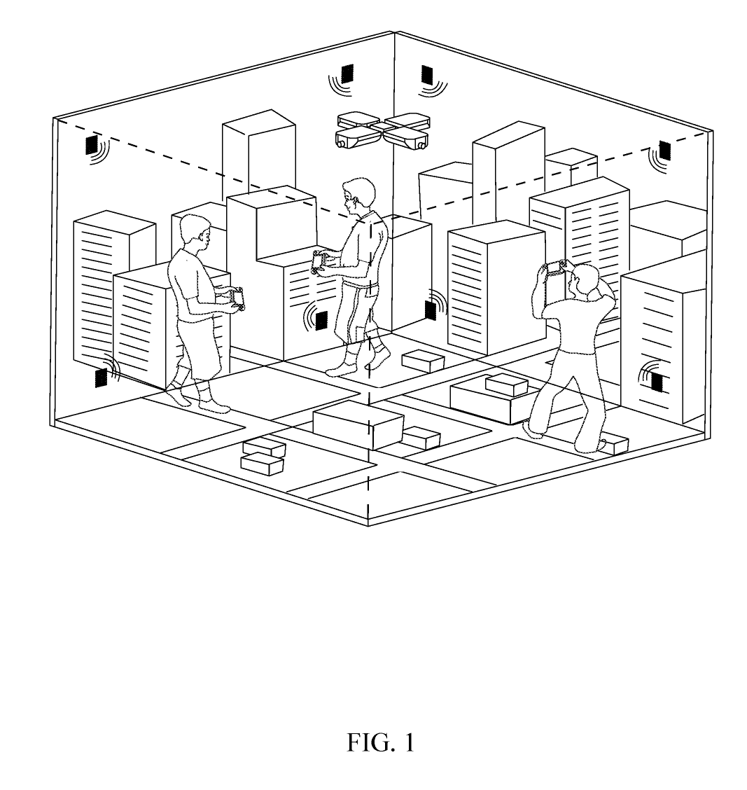

The present invention is a system and method for a gaming immersion room. In particular, the present invention utilizes a room equipped with a plurality of display devices as well as a surround sound system to audio-visually output gaming content within the room in order to fully immerse a user(s) in the game. The player is able to move freely within the room and interact with the game through the use of a controller. The present invention is geared towards a multi-player mode, where a multitude of players are within the room, playing the game simultaneously as seen in FIG. 1.

The present invention comprises a system and a method that provide a novel gaming experience. The method is executed by the system in the form of a software application. The system of the present invention comprises the physical components including, but not limited to, an at least one immersion room, an at least one audiovisual system, an at least one server, and an at least one hand-held controller. The immersion room includes an at least one wall (Step A); the at least one wall may include a floor, a lateral wall, and/or a ceiling. The immersion room may be altered to various other designs to meet needs of a game and/or to provide an additional gaming aspect. For example, in one embodiment the lateral wall includes four separate walls connected together at 90 degree angles. In another embodiment, the lateral wall comprises a single wall that is curved in an annular fashion to eliminate corners and breaks in the display of content in order to facilitate a virtual experience. The number of players that the present invention can accommodate is directly dependent on the size of the immersion room, and as such the size is the only limiting factor. Therefore, the size of the room is subject to change; the ideal immersion room includes four lateral walls and is a 40 by 20 feet area.

The audiovisual system is internally integrated into the immersion room in order to audio-visually output the content of a gaming application within the immersion room (Step B). The audiovisual system displays graphical data of the gaming application onto the internal surfaces of the immersion room through a multitude of display devices. A display device is any technology capable of displaying a sequence of images onto a surface at a relatively fast rate to create a fluid motion picture. The audiovisual system may use an at least one projector and/or an at least one integrated display screen as the display device(s). In the preferred embodiment of the present invention, the at least one projector comprises a plurality of projectors. The plurality of projectors are integrated into or fastened to the center of the ceiling of the immersion room, preferably concealed to blend in with the ceiling. Each of the projectors is oriented to display graphic data onto a specific portion of the immersion room such that when turned on simultaneously, every square inch of the floor and the lateral wall is covered with running images from the gaming application. A higher number of projectors may be used to increase the sharpness and resolution of the picture being displayed onto the immersion room.

In an alternative embodiment of the present invention, the at least one integrated display screen is used instead or in conjunction with the projectors. The at least one integrated display screen comprises a plurality of integrated display screens, wherein each of the integrated display screens is attached/integrated to a specific portion of the immersion room. Additionally, a thick glass is used to cover each of the integrated display screens to allow the players to walk around freely, without damaging the equipment. The plurality of integrated speakers sounds audio data of the gaming application in order to create a virtual experience for the players from an acoustic perspective. It is preferred that the plurality of integrated speakers is distributed about the immersion room in an inconspicuous fashion such that their presence does not distract the users. The integrated speakers may be attached to or integrated into the lateral walls, the floor, and/or the ceiling through a variety of means. Type of speakers that may be used include, but are not limited to, woofers, mid-range drivers, sub-woofers, full-range drivers, tweeters, and coaxial drivers.

The hand-held controller is a physical device which allows each of the players to interact with the gaming application through a direct connection to the server. The hand-held controller is communicably connected to the server. Various different gaming controllers may be used for the hand-held controller component including any existing controllers used in modern gaming console systems. Additional devices that may be used as the hand-held controller include mobile devices such as smartphones, tablets, laptops, and other similar portable computing devices. In the preferred embodiment, the hand-held controller is a tablet with integrated gaming controls and a touchscreen. This allows a portion of the game to be displayed on the player's hand-held controller, providing the player with customized information.

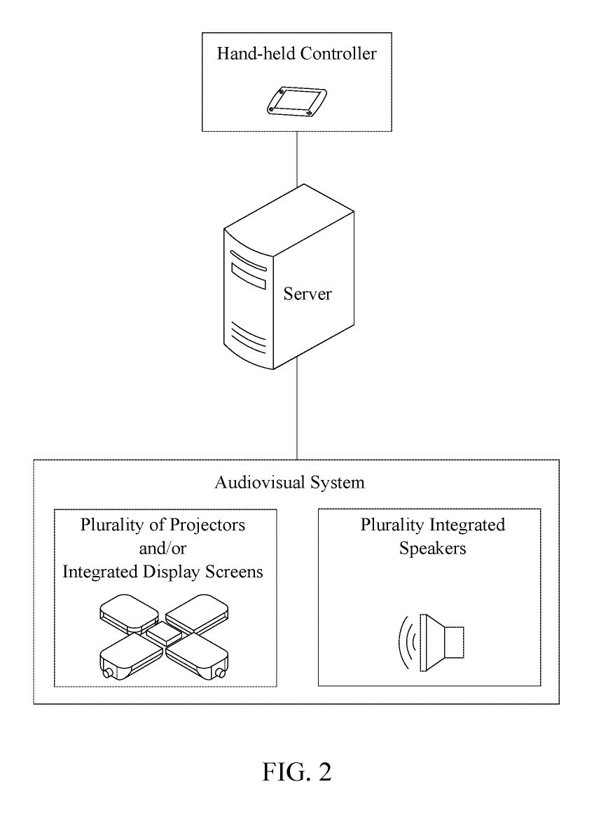

The server runs the gaming application and controls the various components of the present invention. In particular, the server executes the game, outputs the graphical data to the display devices, outputs the audio data to the integrated speakers, receives input from the hand-held controllers, and performs other functions necessary for the operations of the present invention. The server may be equipped with multiple storage devices, wireless data transmission devise, a plurality of graphics cards, an interface operating system, a plurality of mother boards, and an Ethernet port to name a few non-limiting examples. The server may also be equipped with various software components necessary for the function of the present invention. The audiovisual system and the hand-held controller are communicably coupled to the server through either a physical electrical connection or a wireless connection as depicted in FIG. 2; in case of a wireless connection it is implied that the constituents of the audiovisual system are capable of wireless data transmission (Step C). The server uses the design of the immersion room in conjunction with the audiovisual system to visually and acoustically immerse the user in a game.

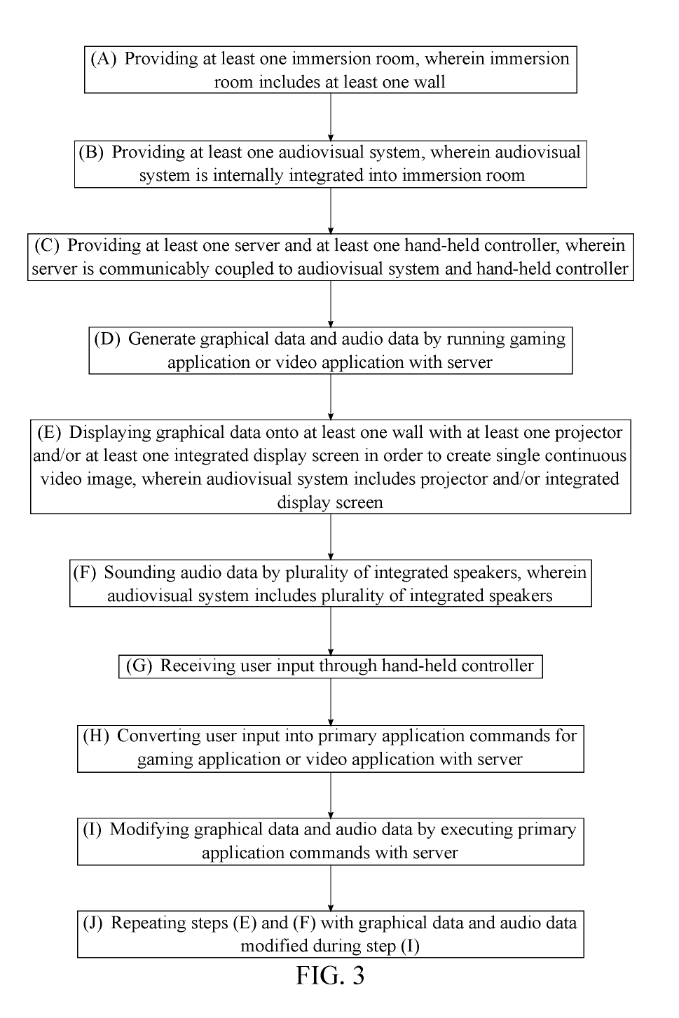

Referring to FIG. 3, the overall process for the present invention are the steps that need to be taken in order utilize a room as a medium for a game. The overall process begins with the server generating the graphical data and the audio data by running the gaming application or a video application (Step D). The graphical data is a set of instructions for visually displaying the gaming application for the projector(s) and/or the integrated display screen. The audio data is a set of instructions for the integrated speakers. Next, the graphical data is displayed onto the at least one wall of the immersion room with the projector and/or integrated display screen in order to create a single continuous video image (Step E). Preferably, the graphical data is displayed onto the floor and the lateral wall of the immersion room to fully immerse the users in the game; the ceiling is preferably painted black so as to hide the audiovisual systems as well as to not distract the player. Simultaneously, the audio data is sounded by the integrated speakers to compliment the graphical data of the gaming application or video application (Step F).

It is preferred that the audio data and the integrated speakers are arranged in a surround sound configuration in order to achieve an enriched sound affect. Next, the server receives user input through the hand-held controller for the gaming application (Step G). The user input is any signal produced by the hand-held controller in response to the player pressing a button or touching the touchscreen on the hand-held controller. The user input is converted into primary application commands for the gaming application or video application with the server (Step H). For example, inputting a direction on the hand-held controller through a joystick button will translate to primary application commands which move a specific unit/character forward by a certain distance. The primary application commands are then executed by the server to modify the graphical data and the audio data to reflect the user input (Step J). Finally, Step E through Step F are repeated with the graphical data and the audio data modified during Step I (Step J) until the end of the gaming application or the conclusion of the video application. This provides a real time response in between the gaming application and the user input. More specifically, in each iteration each new user input modifies the graphical data being displayed and the audio data being played by the integrated speakers.

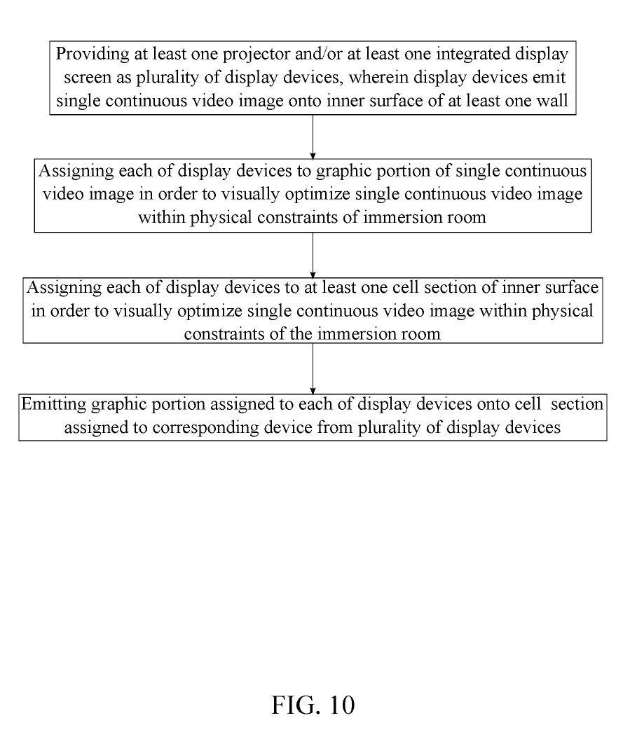

Referring to FIG. 1 and FIG. 10, the present invention provides a novel gaming experience by displaying the single continuous video image onto the inside surfaces of the immersion room. The single continuous video image engulfs the player in gaming content as it is displayed on the majority of the walls of the immersion room. This is achieved through the use of a plurality of display devices, wherein the at least one projector and/or the at least one integrated display screens are included within the plurality of display devices. More specifically, the display devices emit the single continuous video image onto an inner surface of the at least one wall. It is preferred that the single continuous video image is emitted onto the inner surface of the floor and the lateral walls. To create the single continuous video image, each of the display devices is first assigned to a graphic portion of the single continuous image in order to visually optimize the single continuous image within the physical constraints of the immersion room. Additionally, each of the display devices is assigned to an at least one cell section of the inner surface in order to visually optimize the single continuous image within the physical constraints of the immersion room. This is pre-set prior to implementing the present invention through positioning and attaching the display devices inside the immersion room. During the overall process, the graphic portion assigned to each of the display devices is emitted onto the cell section assigned to a corresponding device from the plurality of display devices in order to create the single continuous video image.

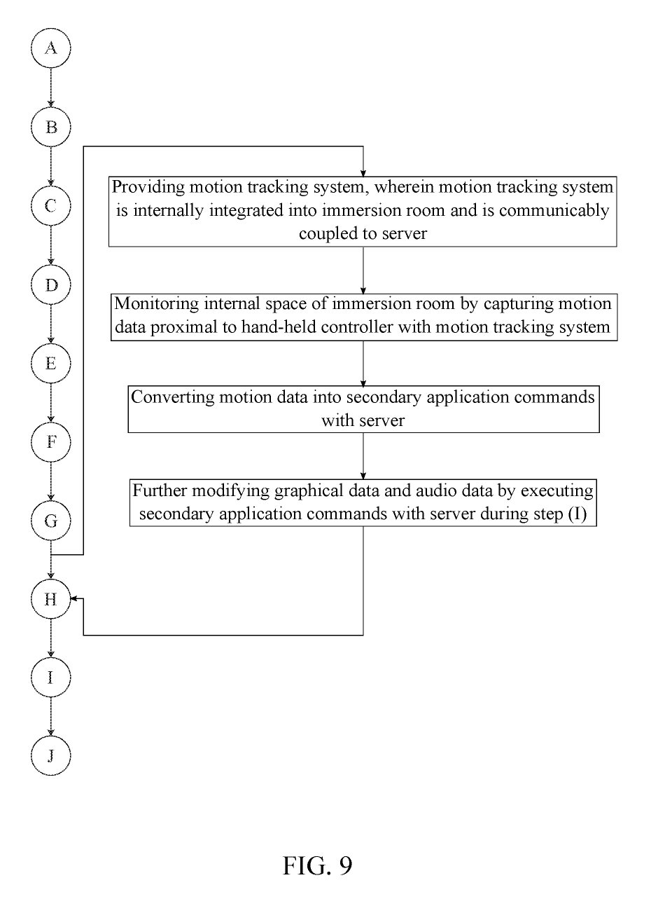

Because the majority of the internal surface of the immersion room is used as a medium for displaying the graphical data, the player is free to walk around and view the graphical data from any perspective. This feature is particularly novel in gaming applications where the player controls a specific unit, person or vehicle for example, because the player is able to follow and control his or her specific unit with ease, thus creating a unique gaming experience. Furthermore, the ability to freely walk around the immersion room while interacting with the gaming application lends itself to a variety of different gaming experiences and gaming features. For example, in one embodiment of the present invention, the system further comprises a motion tracking system that is internally integrated into the immersion room and is communicably coupled to the server as seen in FIG. 9.

The motion tracking system gathers motion data inside the immersion room and converts the motion data into application commands for the gaming application. This allows the player to interact with the gaming application simply through the player's body movement and/or actions. More specifically, the motion tracking system monitors an internal space of the immersion room by capturing motion data proximal to the hand-held controller; this captures the movement of the player and subsequently any physical motions being made by the player. The motion data is then converted into secondary application commands with the server. The graphical data and the audio data are then further modified by executing the secondary application commands with the server during Step I. For example, the player may redirect the movement of a unit by simply moving across the immersion room and the unit will follow the user within the immersion room. A variety of software, methods, and devices may be used for the motion tracking system. One popular method includes utilizing tracking cameras with or without physical markers. Another method includes using sensing devices attached to the user that measure inertia or mechanical motion of the user.

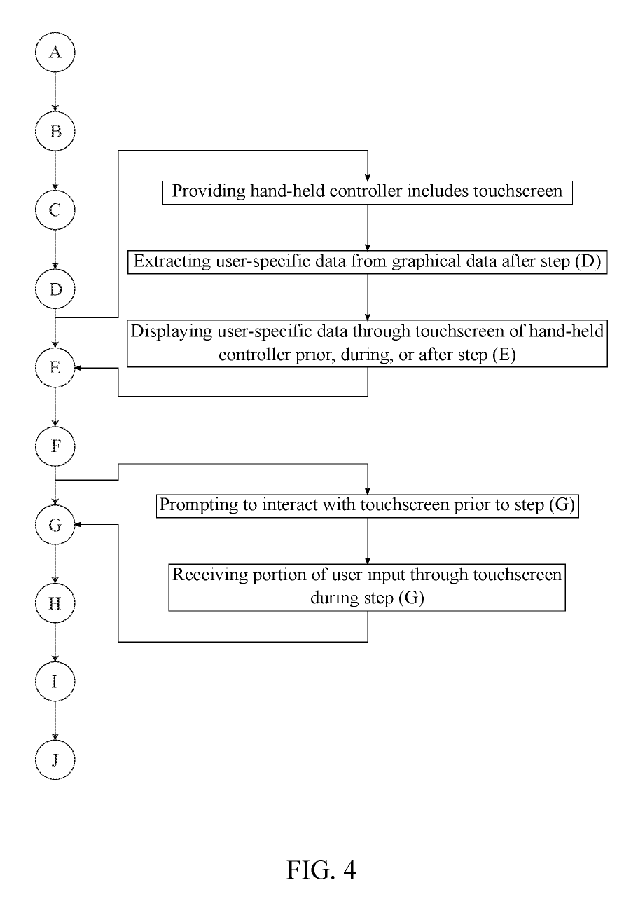

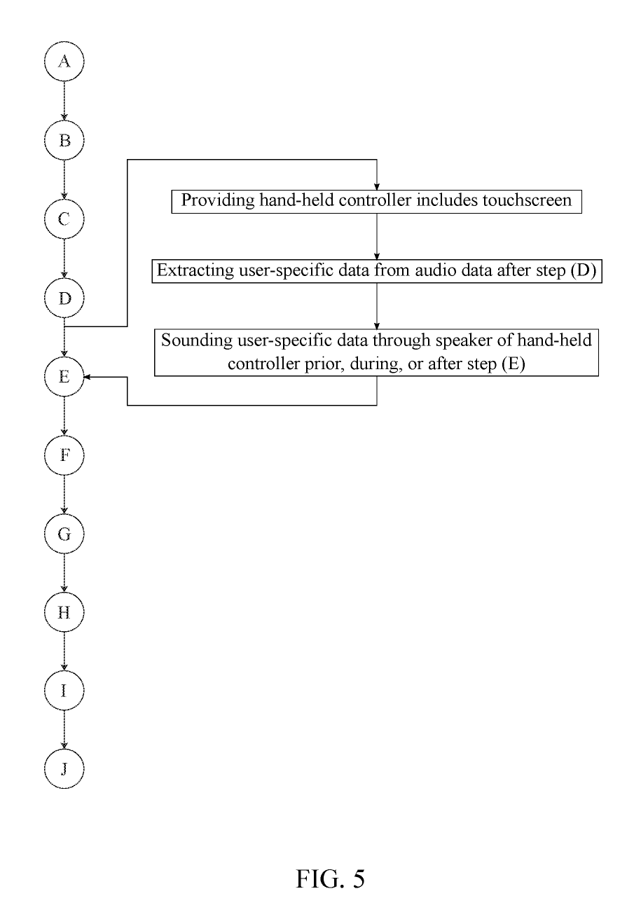

In alternative embodiments of the present invention, the hand-held controller may include a touchscreen and a speaker. Referring to FIG. 4 and FIG. 5, the touchscreen provides an additional means for receiving input from the player as well as displaying the graphical data to the player. More specifically, the present invention prompts the player to interact with the touchscreen prior to Step G by displaying a variety of options on the touchscreen; the player needs to simply press on the touchscreen to select one of the options. The server receives a portion of the user input through the touchscreen during Step G, which is then used to modify the graphical data and the audio data as described above. Additionally, the touchscreen provides an additional display screen that may display graphical data in addition to the display devices integrated into the immersion room, especially graphical data that is related to the player's status within the gaming application. In order to utilize the touchscreen in this fashion, the system first extracts user-specific data from the graphical data after Step D. User-specific data refers to any information which relates to the player's status within the gaming application; some examples includes a unit's health status, the unit's location on a map, ammo spent and ammo left, time left until end of the match, and other similar information. Although any other information from the gaming application may be designated as user-specific data. The user-specific data is then displayed through the touchscreen of the hand-held controller prior, during, and after Step E. A similar process is used for the audio data. The system extracts user-specific data from the audio data after Step D. Then the user-specific data is sounded through the speaker of the hand-held controller prior, during, or after Step E.

As mentioned above, the present invention is geared towards a multi-player configuration. For a multi-player configuration, the overall process is executed for each of a plurality of user accounts simultaneously, thus allowing a multitude of players to interact with gaming application and therefore with each other at the same time. The user account is the means by which the player interacts with the present invention. As a result, the present invention lends itself to a wide variety of gaming modes and gaming application. Some of the type of gaming modes include single player mode, multi-player co-op mode, and multi-player versus mode. The present invention can be configured to allow players to play against the computer together or against other players present in the immersion room. In the case of a multi-player mode, the at least one hand-held controller includes a plurality of hand-held controllers, wherein each player is provided with one of the hand-held controllers.

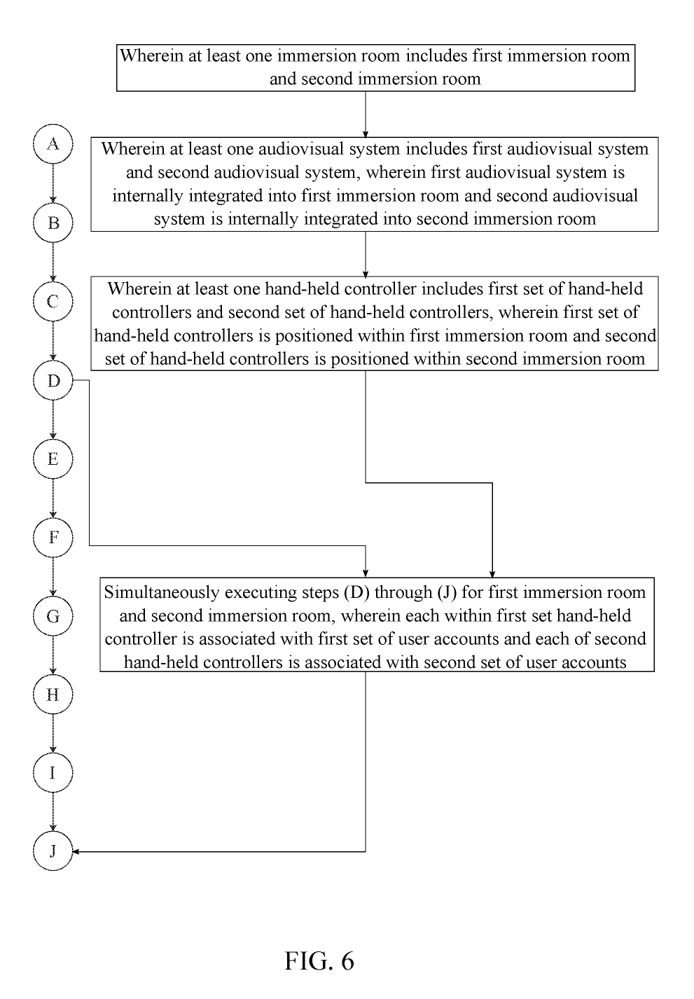

In one embodiment of the present invention, the plurality of user account includes a first set of user accounts and a second set of user accounts, essentially dividing the multitude of players into two teams. In this embodiment, referring to FIG. 6, the at least one immersion room includes a first immersion room and a second immersion room. The first set of user accounts refers to a first group of players in the first immersion room and the second set of user accounts refers to a second group of players in the second immersion room. This configuration depicts a gaming mode where the two groups of players play against each other from two separate locations. The at least one audiovisual system includes a first audiovisual system and a second audiovisual system. The first audiovisual system is internally integrated into the first immersion room and the second audiovisual system is internally integrated into the second immersion room. Furthermore, the at least one hand-held controller includes a first set of hand-held controllers and a second set of hand-held controllers. The first set of hand-held controllers is positioned within the first immersion room and is associated with the first set of user accounts, i.e. the first group of players. The second set of hand-held controllers is positioned within the second immersion room and is associated with the second set of user accounts, i.e. the second group of players. In relation to the method of the present invention for this particular embodiment, Step D through Step J are simultaneously executed for the first immersion room and the second immersion room.

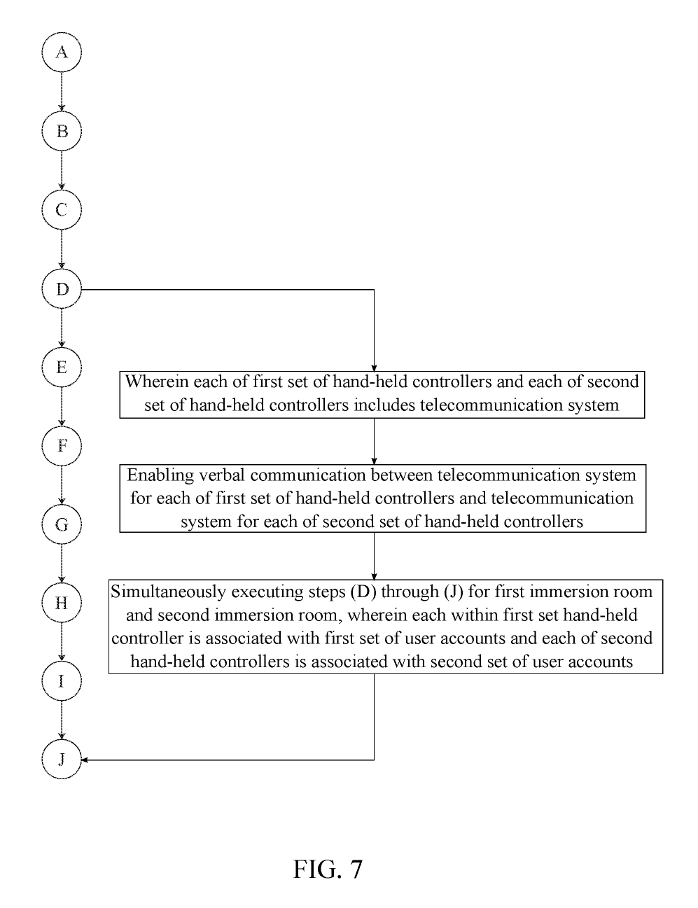

Referring to FIG. 7, an additional feature that may be implemented for the group versus group embodiment is allowing the first group of players to communicate with the second group of players. For this feature, each of the first set of hand-held controllers and each of the second hand-held controllers includes a telecommunication system. The telecommunication system includes a microphone and a wireless communication device. Through the telecommunication system, the present invention allows the first group of players to communicate with the second group of player. More specifically, the system enables verbal communication between the telecommunication system for each of the first set of hand-held controllers and the telecommunication system for each of the second set of hand-held controllers. In addition, the players are able to communicate within their respective group of players through the telecommunication system of each of the hand-held controllers.

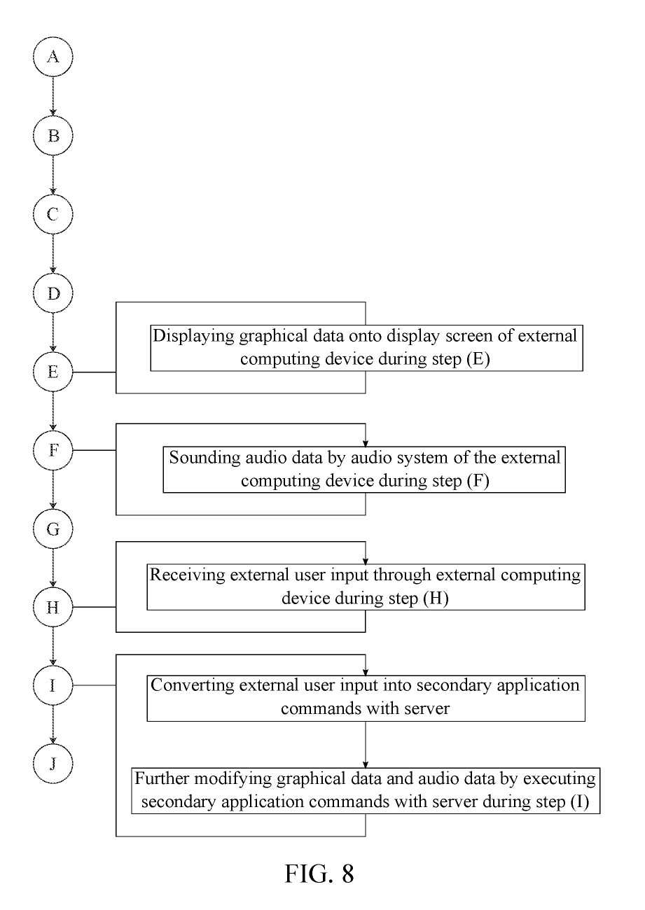

In yet another embodiment, referring to FIG. 8, the present invention allows individuals outside of the room to interact with the gaming application and play along-side the players inside the immersion room through the use of an external computing device. The external computing device is communicably coupled to the server. Type of devices that may be used for the external computing device includes, but is not limited to, smartphones, laptops, tablets, and other similar portable computing devices. In relation to the overall process, first, the graphical data is displayed onto a display screen of the external computing device during Step E. Similarly, the audio data is sounded by an audio system of the external computing device during Step F. Next, external user input is received through the external computing device during Step H. This is the means with which the individual outside of the room interacts with and plays the gaming application. The external user input is then converted into secondary application commands by the server. The graphical data and audio data are then further modified by executing the secondary application commands with the server during Step I.

Although the invention has been explained in relation to its preferred embodiment, it is to be understood that many other possible modifications and variations can be made without departing from the spirit and scope of the invention as hereinafter claimed.

What is claimed is:

1. A method for an immersive gaming theater with seamless video display comprises the steps of:
(A) providing an at least one immersion room, wherein the immersion room includes an at least one wall;
(B) providing an at least one audiovisual system, wherein the audiovisual system is internally integrated into the immersion room;
(C) providing an at least one server and an at least one hand-held controller, wherein the server is communicably coupled to the audiovisual system and the hand-held controller;
(D) generate graphical data and audio data by running a gaming application or a video application with the server;
(E) displaying the graphical data onto the at least one wall with an at least one projector and/or an at least one integrated display screen in order to create a single continuous video image, wherein the audiovisual system includes the projector and/or the integrated display screen;
(F) sounding the audio data by a plurality of integrated speakers, wherein the audiovisual system includes the plurality of integrated speakers;
(G) receiving user input through the hand-held controller
(H) converting the user input into primary application commands for the gaming application or video application with the server;
(I) modifying the graphical data and the audio data by executing the primary application commands with the server; and
(J) repeating steps (E) and (F) with the graphical data and the audio data modified during step (I).

2. The method for an enhanced immersion gaming room system as claimed in claim 1 comprises the steps of:
providing the hand-held controller includes a touchscreen;
extracting user-specific data from the graphical data after step (D); and
displaying user-specific data through the touchscreen of the hand-held controller prior, during, or after step (E).

3. The method for an immersive gaming theater with seamless video display as claimed in claim 1 comprises the steps of:
providing the hand-held controller includes a touchscreen;
prompting to interact with the touchscreen prior to step (G); and
receiving a portion of the user input through the touchscreen during step (G).

4. The method for an immersive gaming theater with seamless video display as claimed in claim 1 comprises the steps of:
providing the hand-held controller includes a speaker;
extracting user-specific data from the audio data after step (D); and
sounding user-specific data through the speaker of the hand-held controller prior, during, or after step (E).

5. The method for an immersive gaming theater with seamless video display as claimed in claim 1 comprises the steps of:
wherein the at least one immersion room includes a first immersion room and a second immersion room;
wherein the at least one audiovisual system includes a first audiovisual system and a second audiovisual system, wherein the first audiovisual system is internally integrated into the first immersion room and the second audiovisual system is internally integrated into the second immersion room;
wherein the at least one hand-held controller includes a first set of hand-held controllers and a second set of hand-held controllers, wherein the first set of hand-held controllers is positioned within the first immersion room and the second set of hand-held controllers is positioned within the second immersion room; and
simultaneously executing steps (D) through (J) for the first immersion room and the second immersion room, wherein each within the first set hand-held controller is associated with a first set of user accounts and each of the second hand-held controllers is associated with a second set of user accounts.

6. The method for an immersive gaming theater with seamless video display as claimed in claim 5 comprises the steps of:
wherein each of the first set of hand-held controllers and each of the second set of hand-held controllers includes a telecommunication system; and
enabling verbal communication between the telecommunication system for each of the first set of hand-held controllers and the telecommunication system for each of the second set of hand-held controllers.

7. The method for an immersive gaming theater with seamless video display as claimed in claim 1 comprises the steps of:
providing an external computing device, wherein the external computing device is communicably coupled to the server;
displaying the graphical data onto a display screen of the external computing device during step (E);
sounding the audio data by an audio system of the external computing device during step (F);
receiving external user input through the external computing device during step (H);
converting external user input into secondary application commands with the server; and
further modifying the graphical data and the audio data by executing the secondary application commands with the server during step (I).

8. The method for an immersive gaming theater with seamless video display as claimed in claim 1 comprises the steps of:
providing a motion tracking system, wherein the motion tracking system is internally integrated into the immersion room and is communicably coupled to the server;
monitoring an internal space of the immersion room by capturing motion data proximal to the hand-held controller with the motion tracking system;
converting the motion data into secondary application commands with the server; and
further modifying the graphical data and the audio data by executing the secondary application commands with the server during step (I).

9. The method for an enhanced immersion gaming room system as claimed in claim 1 comprises the steps of:
providing the at least one projector and/or the at least one integrated display screen as a plurality of display devices, wherein the display devices emit the single continuous video image onto an inner surface of the at least one wall;
assigning each of the display devices to a graphic portion of the single continuous video image in order to visually optimize the single continuous video image within physical constraints of the immersion room;
assigning each of the display devices to an at least one cell section of the inner surface in order to visually optimize the single continuous video image within physical constraints of the immersion room; and
emitting the graphic portion assigned to each of the display devices onto the cell section assigned to a corresponding device from the plurality of display devices.
